(19) United States
(12) Patent Application Publication
(10) Pub. No.: US 2026/0005467 A1
(43) Pub. Date: Jan. 1, 2026

(54) VIBRATION DAMPING AND CLEARANCE COMPENSATION ELEMENT

(71) Applicant: Aptiv Technologies AG, Schaffhausen (CH)

(72) Inventors: Norbert DOBERNIG, Lauf (DE); Mirko POSMIK, Fürth (DE)

(21) Appl. No.: 19/220,662

(22) Filed: May 28, 2025

(30) Foreign Application Priority Data
Jul. 1, 2024 (EP) 24185717.6

(51) Int. Cl. H01R 13/533; H01R 13/40

(52) U.S. Cl. CPC H01R 13/533; H01R 13/40

(57) ABSTRACT

This disclosure relates to a vibration damping and clearance compensation element for an electrical connector, featuring a flexible wall with a first and second main surface, mounted in a cantilevered manner. A hollow space is positioned adjacent to the first main surface of the flexible wall, allowing for enhanced flexibility and vibration absorption. At least one contact element extends from the second main surface of the flexible wall, providing electrical connectivity while accommodating movement and misalignment. This configuration effectively dampens vibrations and compensates for clearance variations, ensuring reliable electrical connections under dynamic conditions. The design is particularly suited for applications requiring robust performance in environments subject to mechanical stress and movement, enhancing the durability and reliability of electrical connectors.

### CROSS-REFERENCE TO RELATED APPLICATION

This application claims the benefit of and priority to European Application No. 24185717.6 filed with the European Patent Office on Jul. 1, 2024, the contents of which are incorporated by reference herein.

### TECHNICAL FIELD

The present disclosure relates to a vibration damping and clearance compensation element for an electrical connector. The present disclosure further relates to an electrical connector, a ring compensator of an electrical connector, and a terminal position assurance element each including the vibration damping and clearance compensation element.

### BACKGROUND

Electrical connectors and electrical connector assemblies are commonly used to connect various cables, for example telecommunication cables, common networking cables, signaling cables. or any other electrical wiring. In this context electrical connectors are used for joining electrical circuits. A male ended plug of an electrical connector may be configured to be connected to a respective female ended jack of a corresponding counter-connector.

Automotive electrical connectors should be designed to withstand extreme vibration class requirements e.g., in applications close to the engine, in combination with high ingress protection (IP) rating, temperature, and watertightness requirements. In these applications, it is important to reduce relative movements between each single component. Thus, it is necessary to have a precise fit between female and male connector to avoid fretting corrosion and nonuniform contact pressure when a seal used. However, providing a precisely fitting plug-in connection usually has a negative influence on the mating force. The more precisely the connectors fit, the higher the mating force will be.

So called “crush ribs” which are thin ribs extending in mating direction and arranged all around the housing shroud are used for improving a tight seat between corresponding counter-connector. These crush ribs provide a line of contact between the mated connectors and reduce the clearance between female and male connectors with lower friction and thus lower mating force. However, such crush ribs need to be designed by a complex debugging of the molding tools and by adjusting the height of these ribs in coordination with the remaining gap size between each single component. Further, such crush ribs cannot be completely demolded from the mold without a draft angle, such that the crush ribs cannot provide a uniform contact pressure over the entire length. Therefore, crush ribs are very delicately designed to be crushed or compressed when the connectors are mated together, making it difficult to ensure their dimensional accuracy.

In view of the issues presented above, there is a need to find better solutions for providing a precise fit between female and male connector to avoid fretting corrosion and nonuniform contact pressure when a seal used, particularly for automotive connectors.

### SUMMARY

The previously mentioned problems are at least partially solved by a vibration damping and clearance compensation element of an electrical connector which includes a flexible wall, having a first main surface and a second main surface. The flexible wall is mounted in a cantilevered fashion. A hollow space is located adjacent to the first main surface of the flexible wall. At least one contact element extends from the second main surface of the flexible wall.

The vibration damping and clearance compensation element reduces the vibrations of an electrical connector when mated with a corresponding counter-connector and at the same time ensures uniform contact pressure of a seal on a collar of the corresponding counter-connector. Further, an air gap between the socket housing of the connector and a pin header is equalized and vibrations are reduced. The consistent distance all around the mated connector ensures a uniform contact pressure of the seal on the sealing surface in the corresponding counter-connector.

The number of these vibration damping and clearance compensation elements can be chosen individually depending on the component size and the vibrations assumed. Preferably, the vibration damping and clearance compensation element can be used favorably within an automotive electrical connector which is on the one hand subjected to vibrations and which on the other hand should be watertight.

The cantilevered flexible wall on the one hand has an elasticity to compensate for any manufacturing tolerances and compensates any desired clearances and on the other hand provides sufficient compression force onto the contact element to dampen any vibrations within the electrical connector. The hollow space provides enough room for the flexible wall to be flexibly bent during use. The contact element provides a defined contact surface of the vibration damping and clearance compensation element with the corresponding counter-connector and further reduces the mating force compared to crush ribs being used instead.

Preferably, the flexible wall includes at least one unsupported edge and at least one supported edge. The flexible wall is connected to the connector component by the supported edge, whereas the unsupported edge ensures the ability to bend the flexible wall into the hollow space.

Preferably, the flexible wall has a first unsupported edge, a second unsupported edge, a first supported edge and a second supported edge. The first unsupported edge and the second unsupported edge contact each other. The first supported edge and the second supported edge may also contact each other. The flexible wall is preferably supported on two connected ones of four edges, which provides the necessary amount of flexibility and stiffness for the clearance compensation and vibration damping.

Preferably, the first main surface and the second main surface are parallel to each other.

Preferably, the first main surface and the second main surface are flat. The vibration damping and clearance compensation element can therefore be configured to a substantially flat surface of a connector component to be vibration damped.

Alternatively, the first main surface and the second main surface are preferably curved in one direction. Thereby, the vibration damping and clearance compensation element can be configured to a curved surface of a connector component to be vibration damped.

Preferably, the first unsupported edge and the second unsupported edge contact each other.

Preferably, the first supported edge and the second supported edge contact each other.

Preferably, the supported and unsupported edges of the flexible wall form a rectangle or a trapezoid.

Preferably, the flexible wall includes a curved unsupported edge and/or a curved supported edge.

Preferably, the contact element includes an overall shape of a cylinder section.

Preferably, the vibration damping and clearance compensation element is made of a flexible material.

The above-mentioned objective is also achieved by a ring compensator or seal holder of an electrical connector including at least one vibration damping and clearance compensation element as described above.

The above-mentioned objective is also achieved by a terminal position assurance element of an electrical connector including at least one vibration damping and clearance compensation element as described above.

The above-mentioned objective is also achieved by an electrical connector including at least one vibration damping and clearance compensation element as described above and/or a ring compensator or seal holder as described above and/or a terminal position assurance element as described above.

### BRIEF DESCRIPTION OF THE DRAWINGS

Exemplary embodiments and functions of the present disclosure will be described in more detail in the following with reference to the drawings described below. In the various figures, similar or identical elements have the same reference numbers.

FIG. 1 shows an isometric view of a component of an electrical connector including a vibration damping and clearance compensation element according to some embodiments.

FIG. 2 shows an isometric view of a ring compensator of an electrical connector including two vibration damping and clearance compensation elements according to some embodiments.

FIG. 3A shows an isometric view of a female electrical connector with a ring compensator of FIG. 2 according to some embodiments.

FIG. 3B shows a detailed view of FIG. 3A with a vibration damping and clearance compensation element of the ring compensator of FIG. 2 according to some embodiments.

FIG. 4 shows a frontal view of the female electrical connector of FIG. 3A according to some embodiments.

FIG. 5 shows a vertical cross-sectional view of the female electrical connector of FIG. 3A connected to a corresponding male socket according to some embodiments.

FIG. 6 shows a horizontal cross-sectional view of the female electrical connector of FIG. 3A connected to a corresponding male socket according to some embodiments.

FIG. 7 shows an isometric view of a terminal position assurance element (TPA) according to some embodiments.

FIG. 8 shows an isometric view of a component of an electrical connector including a vibration damping and clearance compensation element according to some embodiments.

FIG. 9 shows an isometric view of an electrical connector including a vibration damping and clearance compensation element according to some embodiments.

### DETAILED DESCRIPTION

In the subsequent passages, the preferred embodiments of the invention are described with reference to the accompanying figures in more detail. It is noted that further embodiments are certainly possible, and the explanations below are provided by way of example only, without limitation. Throughout the present figures and specification, the same reference numerals refer to the same elements. The figures may not be to scale, and the relative size, proportions, and depiction of elements in the figures may be exaggerated for clarity, illustration, and convenience.

It is noted that when features, aspects, and/or embodiments are described herein by the term “substantially”, manufacturing tolerances must be taken into consideration. In this manner, minor deviations during any kind of manufacturing, assembling or the like may pertain. Further, manufacturing tolerances, aging effects, or other minor defects or the like may pertain. These are all encompassed by the term “substantially”. Although not always explicitly expressed by using the term “substantially”, it is understood that the elements, parts, units, shapes, and/or the like described herein may nevertheless include such manufacturing tolerances.

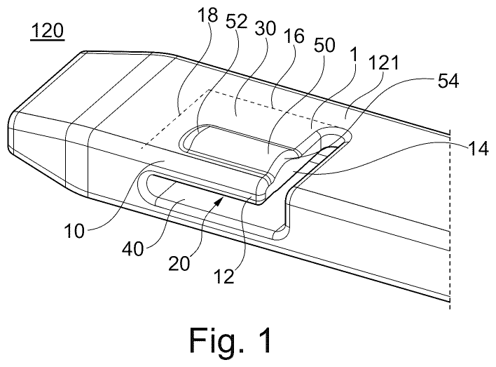

FIG. 1 shows a component of an electrical connector including a first embodiment of a vibration damping and clearance compensation element 1. The vibration damping and clearance compensation element 1 includes a flexible wall 10, a hollow space 40, and a contact element 50. Vibration damping and clearance compensation element 1 compensates clearances or manufacturing tolerances within electrical connectors. Further, due to its elasticity and damping behavior, it dampens vibrations within electrical connectors. Vibration damping and clearance compensation element 1 can preferably be bused at the interface between two electrical connectors to enable low mating forces and ensure proper and reliable connection without play and vibration between the parts. Particularly, vibration damping and clearance compensation element 1 reduces the mating forces compared to prior art connectors with crush ribs.

Flexible wall 10 is mounted in a cantilevered fashion for providing elasticity but also to provide dampening effects. Flexible wall 10 includes a first main surface 20 and a second main surface 30, which are preferably parallel to each other. Further, the first main surface 20 and the second main surface 30 of the first embodiment are preferably flat. In the first embodiment flexible wall 10 includes a first unsupported edge 12, a second unsupported edge 14, a first supported edge 16 and a second supported edge 18. The first unsupported edge 12 and the second unsupported edge 14 contact each other. Similarly, the first supported edge 16 and the second supported edge 18 contact each other. Flexible wall 10 is connected to a body portion 121 of a component 120 of an electrical connector 100 by the supported edges 16, 18. As shown in FIG. 1, the component 120 may be, for example, a tip of a terminal position assurance element (TPA) 120.

The main surfaces 20, 30 of flexible wall 10 preferably have a rectangular or preferably square shape, such that the first unsupported edge 12 and the second unsupported edge 14 contact each other and are arranged rectangular to each other, Likewise, the first supported edge 16 and the second supported edge 18 contact each other and are arranged rectangular to each other.

The contact element 50 of the first embodiment includes an overall shape of a cylinder section. The contact element 50 extends from the second main surface 30 of the flexible wall 10 to the outside of the component 120. In other embodiments, the vibration damping and clearance compensation element 1 may also be arranged at a component of an electrical connector such that the contact element 50 extends to the inside of the component 120. Further, the cylinder axis of the contact element 50 extends substantially perpendicular to the mating direction M. Further, the contact element 50 includes a first rounded end 52 pointing to a supported edge 18 and a second rounded end 54 pointing to an unsupported edge 14.

Hollow space 40 is located adjacent to the first main surface 20 of the flexible wall 10. This arrangement allows the flexible wall 10 to flex into hollow space 40.

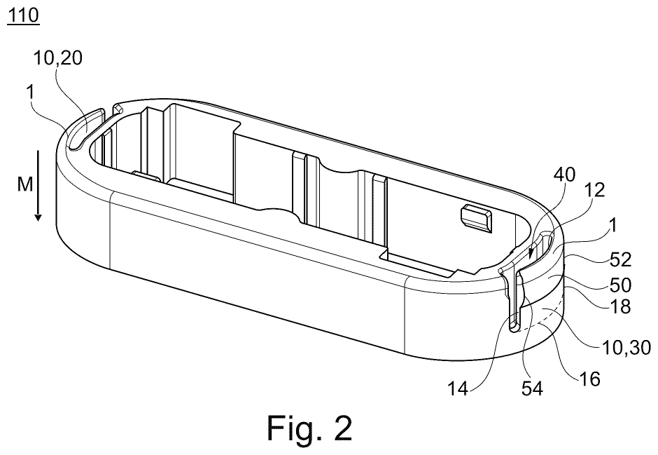

FIG. 2 shows a ring compensator or seal holder 110 of an electrical connector 100 including two vibration damping and clearance compensation elements 1 according to a second embodiment. The vibration damping and clearance compensation elements 1 are arranged at opposite ends of the oval shaped ring compensator or seal holder 110. The ring compensator or seal holder 110 compensates desired voids or manufacturing tolerances between two mating parts of an electrical connector, i.e., between a socket and a plug part. The ring compensator or seal holder 110 thereby enables mating of socket and plug part with low mating forces but also limits vibrations between these parts by compensating the mating clearance to zero. Further, the ring compensator or seal holder 110 holds a seal 108.

In this second embodiment, the vibration damping and clearance compensation element 1 corresponds essentially to the first embodiment. In deviating from the first embodiment, the flexible wall 10 of the vibration damping and clearance compensation elements include a first main surface 20 and a second main surface 30 which are curved in one direction. Preferably, the first main surface 20 and the second main surface 30 are curved in a mating direction M of the electrical connector 100. The vibration damping and clearance compensation elements 1 are an integral part of the ring compensator 110, which is preferably made of a flexible material like ethylene propylene diene monomer (EPDM) rubber, glass-fiber reinforced polybutylene terephthalate (PBT), glass-fiber reinforced polyamide (PA), or like materials.

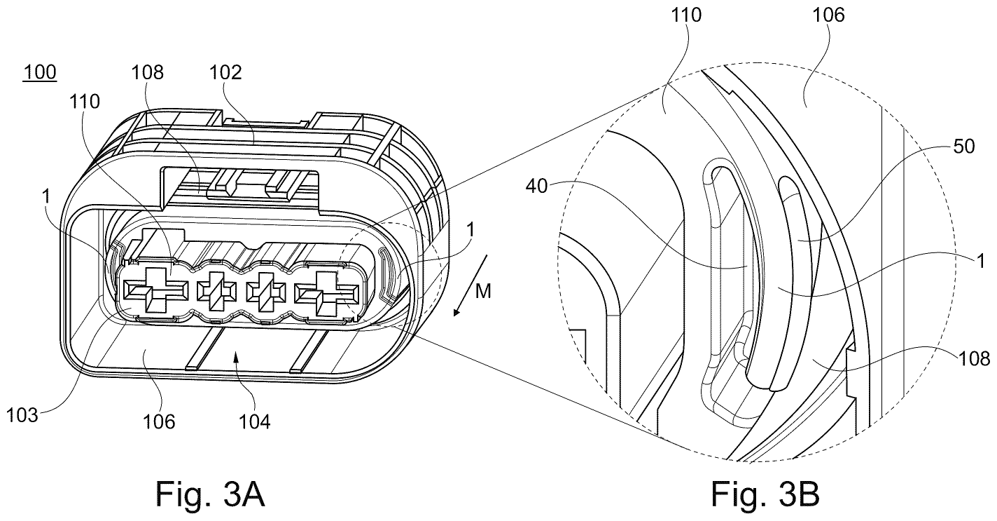

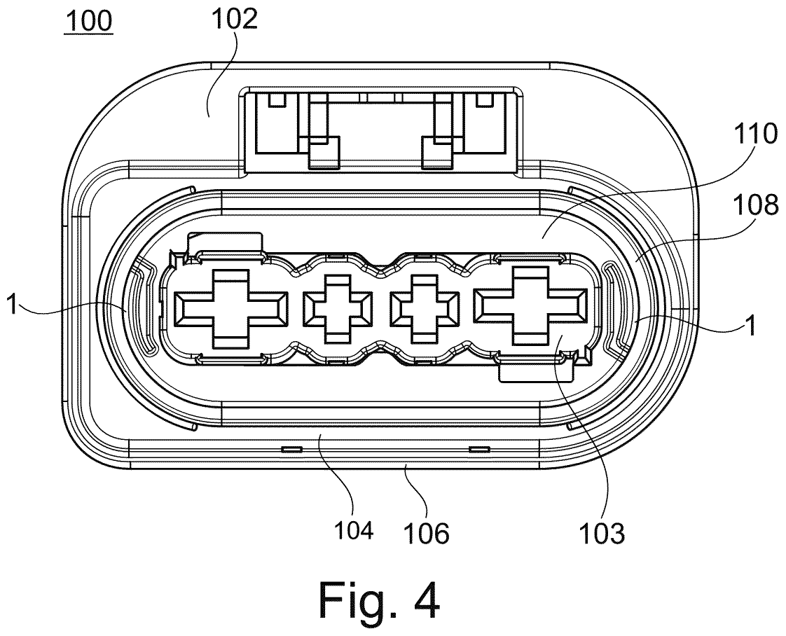

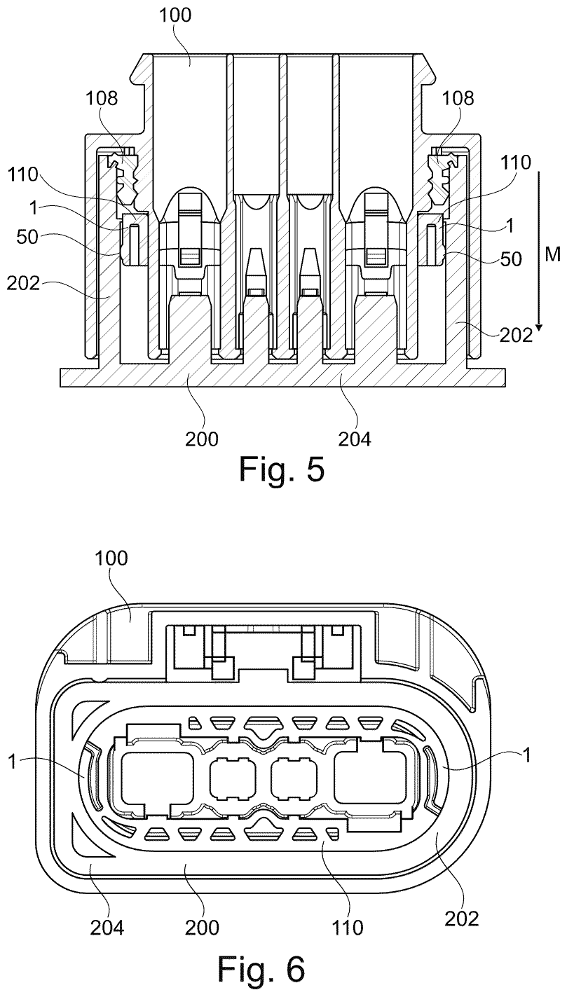

FIGS. 3A to 4 illustrate a female electrical connector 100 including the ring compensator as shown in FIG. 2. The electrical connector 100 further includes an integral housing 102 with a contact holder 103 and a collar 106 surrounding a cavity 104 for receiving a counter-connector 200 (see FIGS. 5 and 6).

The connector 100 further includes the seal 108 to ensure a water-tight connection between connector 100 and a counter-connector 200. The seal 108 is mounted on the connector housing 102 and may be secured in place by the ring compensator or seal holder 110.

FIGS. 5 and 6 show the electrical connector 100 mated with a corresponding counter-connector 200. In the illustrated embodiment, the counter-connector 200 is a male connector. The counter-connector 200 includes a socket housing 204 and a collar 202 that protrudes into the cavity 104 of the connector 100 when the connectors 100, 200 are in mated condition.

The collar 202 abuts the contact elements 50 of the vibration damping and clearance compensation element 1 in the mated condition and elastically bends the flexible walls 10 into the hollow space. 40, thereby reducing play and vibrations between the connectors 100, 200.

Collar 202 further contacts the seal 108 to provide a water-tight connection between the connector 100 and the counter-connector 200.

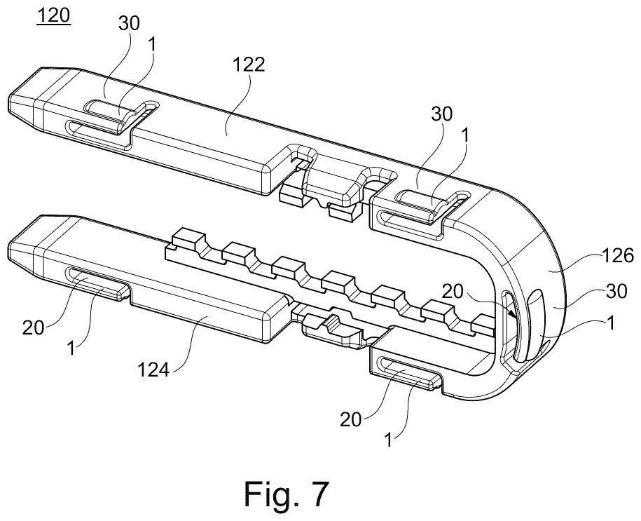

FIG. 7 shows an isometric view of a terminal position assurance element (TPA) 120. The TPA 120 is a component of an electrical connector that ensures that electrical terminals of the connector remain in place. The illustrated TPA 120 essentially has U-shape with a first leg 122 and a second leg 124 that are parallel to each other and that are connected via a curved section 126. The TPA 120 includes at each leg 122 two vibration damping and clearance compensation elements 1 with flat first and second main surfaces 20, 30 according to the first embodiment. These vibration damping and clearance compensation elements 1 are directed to the outside of the legs 122 and 124. In other embodiments they may also be directed to the inside of the legs 122, 124. Further, TPA 120 further includes a vibration damping and clearance compensation element 1 at the curved section 126 of the TPA 120. This vibration damping and clearance compensation element 1 includes a first main surface 20 and the second main surface 30 that are curved, similarly to the second embodiment.

The vibration damping and clearance compensation elements 1 compensate for any voids between the TPA 120 and the corresponding connector element into which the TPA 120 is inserted, particularly a connector housing. Thus, vibration damping and clearance compensation elements 1 reduce any vibrations between the TPA 120 and the socket housing 204 of the counter-connector 200 and ensure that the TPA 120 remains securely in place.

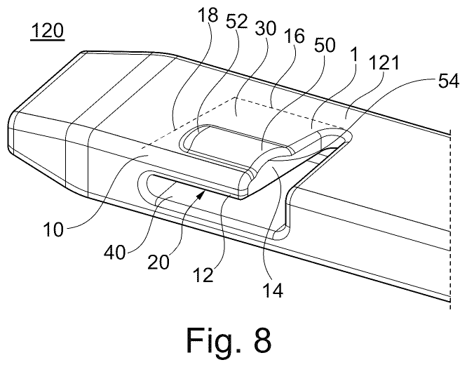

FIG. 8 shows a third embodiment of a vibration damping and clearance compensation element 1. The third embodiment of the vibration damping and clearance compensation element 1 essentially corresponds to the first embodiment of FIG. 1 with the difference being the vibration damping and clearance compensation element 1 including supported and unsupported edges 12, 13, 14, 15 that form a trapezoid. Therefore, the main surfaces 20, 30 of the flexible wall 10 preferably have a trapezoidal shape.

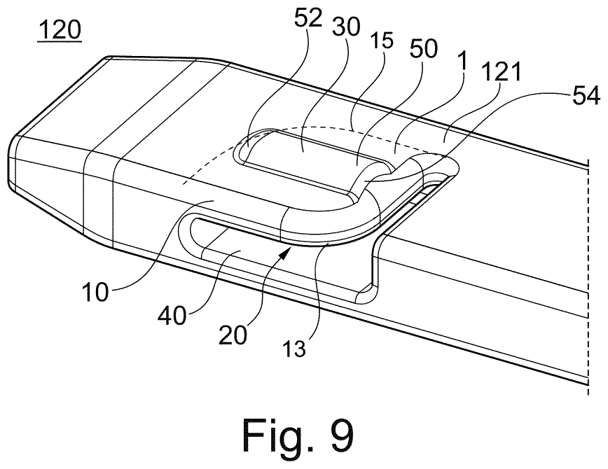

FIG. 9 shows a fourth embodiment of a vibration damping and clearance compensation element 1. The fourth embodiment of the vibration damping and clearance compensation element 1 essentially corresponds to the first embodiment of FIG. 1 with the difference being that flexible wall 10 of the vibration damping and clearance compensation element 1 includes a curved unsupported edge 13 and/or a curved supported edge 15. Therefore, the main surfaces 20, 30 of the flexible wall 10 preferably have a round or oval shape.

While the invention is described with reference to an exemplary embodiment(s), it will be understood by those skilled in the art that various changes may be made, and equivalents may be substituted for elements thereof without departing from the scope of the invention. In addition, many modifications may be made to configure a particular situation or material to the teachings of the invention without departing from the essential scope thereof. Therefore, it is intended that the invention is not limited to the disclosed embodiment(s), but that the invention will include all embodiments falling within the scope of the appended claims.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an”, and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Additionally, while terms of ordinance or orientation may be used herein these elements should not be limited by these terms. All terms of ordinance or orientation, unless stated otherwise, are used for purposes distinguishing one element from another, and do not denote any particular order, order of operations, direction or orientation unless stated otherwise.

### LISTING OF REFERENCE NUMBERS USED

1 vibration damping and clearance compensation element
10 flexible wall
12 first unsupported edge
13 curved unsupported edge
14 second unsupported edge
15 curved supported edge
16 first supported edge
18 second supported edge
20 first main surface
30 second main surface
40 hollow space
50 contact element
52 first rounded end
54 second rounded end
100 electrical connector
102 connector housing
103 contacts holder
104 cavity
106 collar
108 seal
110 ring compensator or seal holder
120 terminal position assurance element (TPA)
121 body portion
122 first leg
124 second leg
126 curved section
200 counter-connector
202 collar
204 socket housing
M mating direction

1. A vibration damping and clearance compensation element of an electrical connector, comprising:
a flexible wall having a first main surface and a second main surface, the flexible wall being mounted in a cantilevered fashion;
a hollow space adjacent to the first main surface of the flexible wall; and
at least one contact element extending from the second main surface of the flexible wall.

2. The vibration damping and clearance compensation element according to claim 1, wherein the flexible wall includes at least one unsupported edge and at least one supported edge.

3. The vibration damping and clearance compensation element according to claim 2, wherein the flexible wall includes a first unsupported edge, a second unsupported edge, a first supported edge and a second supported edge, wherein the first unsupported edge and the second unsupported edge contact each other and the first supported edge, and the second supported edge contact each other.

4. The vibration damping and clearance compensation element according to claim 3, wherein the first unsupported edge and the second unsupported edge contact each other.

5. The vibration damping and clearance compensation element according to claim 3, wherein the first supported edge and the second supported edge contact each other.

6. The vibration damping and clearance compensation element according to claim 5, wherein the supported and unsupported edges of the flexible wall form a rectangle.

7. The vibration damping and clearance compensation element according to claim 5, wherein the supported and unsupported edges of the flexible wall form a trapezoid.

8. The vibration damping and clearance compensation element according to claim 1, wherein the first main surface and the second main surface are parallel to each other.

9. The vibration damping and clearance compensation element according to claim 1, wherein the first main surface and the second main surface are flat.

10. The vibration damping and clearance compensation element according to claim 1, wherein the first main surface and the second main surface are curved in one direction.

11. The vibration damping and clearance compensation element according to claim 1, wherein the flexible wall includes a curved unsupported edge.

12. The vibration damping and clearance compensation element according to claim 1, wherein the flexible wall includes a curved supported edge.

13. The vibration damping and clearance compensation element according to claim 1, wherein the contact element includes an overall shape of a cylinder section.

14. The vibration damping and clearance compensation element according to claim 1, being made of a flexible material.

15. A ring compensator or seal holder of an electrical connector comprising at least one vibration damping and clearance compensation element according to claim 1.

16. A terminal position assurance element of an electrical connector comprising at least one vibration damping and clearance compensation element according to claim 1.

17. An electrical connector comprising at least one vibration damping and clearance compensation element according to claim 1.
